(19) United States
(12) Patent Application Publication
(10) Pub. No.: US 2024/0187689 A1
(43) Pub. Date: Jun. 6, 2024

(54) TELEVISION DISPLAY BLACKOUT CONTROL SYSTEM AND METHOD

(71) Applicant: Christopher Fiore, Costa Mesa, CA (US)

(72) Inventor: Christopher Fiore, Costa Mesa, CA (US)

(21) Appl. No.: 18/076,107

(22) Filed: Dec. 6, 2022

(51) Int. Cl. H04N 21/266; H04N 21/835

(52) U.S. Cl. CPC H04N 21/266; H04N 21/835

(57) ABSTRACT

A television display blackout control system for powering off a display of a television includes a television including a display screen and a speaker. A programmed control circuit is electrically coupled to the display screen and the speaker of the television and is programmed to include a blackout feature to power off or to selectively darken the display screen while continuing to audibly play sound from a video program. An actuator of the controller and is actuatable to engage the blackout feature. A timer module is electrically coupled to the programmed control circuit and counts a set time for engaging the blackout feature when actuated. A memory module is electrically coupled to the control board and is programmed to store a command menu including subcommands of the blackout feature.

### CROSS-REFERENCE TO RELATED APPLICATIONS

### Not Applicable

### STATEMENT REGARDING FEDERALLY SPONSORED RESEARCH OR DEVELOPMENT

### Not Applicable

### THE NAMES OF THE PARTIES TO A JOINT RESEARCH AGREEMENT

### Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

### Not Applicable

### STATEMENT REGARDING PRIOR DISCLOSURES BY THE INVENTOR OR JOINT INVENTOR

### Not Applicable

### BACKGROUND OF THE INVENTION

### (1) Field of the Invention

The disclosure relates to electronic device control systems and more particularly pertains to a new electronic device control system for powering off a display of a television.

### (2) Description of Related Art Including Information Disclosed Under 37 CFR 1.97 and 1.98

The prior art relates to electronic device control systems and includes a variety of systems controlling a television having a display and a speaker. Known prior art does not include an electronic device control system having a programmed control circuit being programmed to power off or to selectively darken a display of a television while audibly playing sound from a video program.

### BRIEF SUMMARY OF THE INVENTION

An embodiment of the disclosure meets the needs presented above by generally comprising a television including a display screen and a speaker. A receiver is electrically coupled to the television. A controller includes a transmitter for wirelessly communicating with the receiver to actuate the television and a plurality of direction controls. A programmed control circuit is electrically coupled to the display screen and the speaker of the television and is programmed to include a blackout feature to power off or to selectively darken the display screen while continuing to audibly play sound from a video program. An actuator of the controller and is actuatable to engage the blackout feature. A timer module is electrically coupled to the programmed control circuit and counts a set time for engaging the blackout feature when actuated. A memory module is electrically coupled to the control board and is programmed to store a command menu including subcommands of the blackout feature.

Another embodiment of the disclosure comprises a method including the steps of powering on a television to actuate a display screen and a speaker of the television. An actuator is engaged with to actuate a blackout feature of the television and to display a command menu on the display screen. A plurality of direction controls is engaged with to select a subcommand from the command menu.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a television display blackout control system according to an embodiment of the disclosure.

FIG. 2 is an in-use view of an embodiment of the disclosure.

FIG. 3 is an in-use view of an embodiment of the disclosure.

FIG. 4 is a flowchart view of an embodiment of the disclosure.

FIG. 5 is a block diagram view of an embodiment of the disclosure.

### DETAILED DESCRIPTION OF THE INVENTION

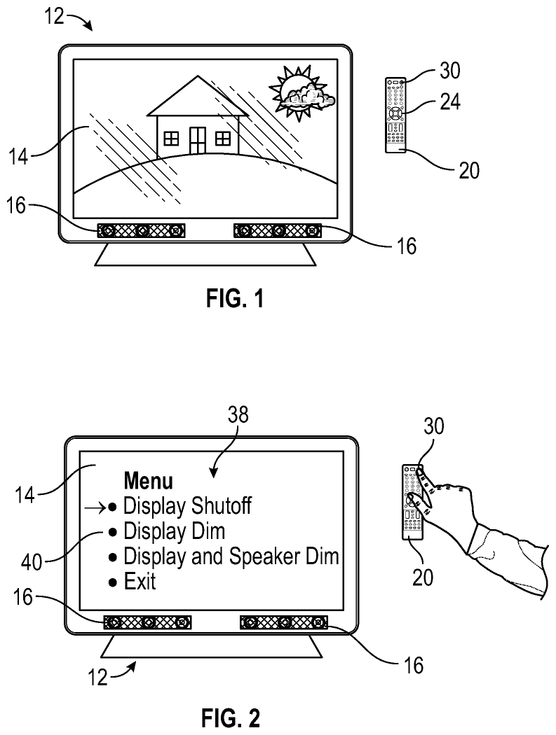

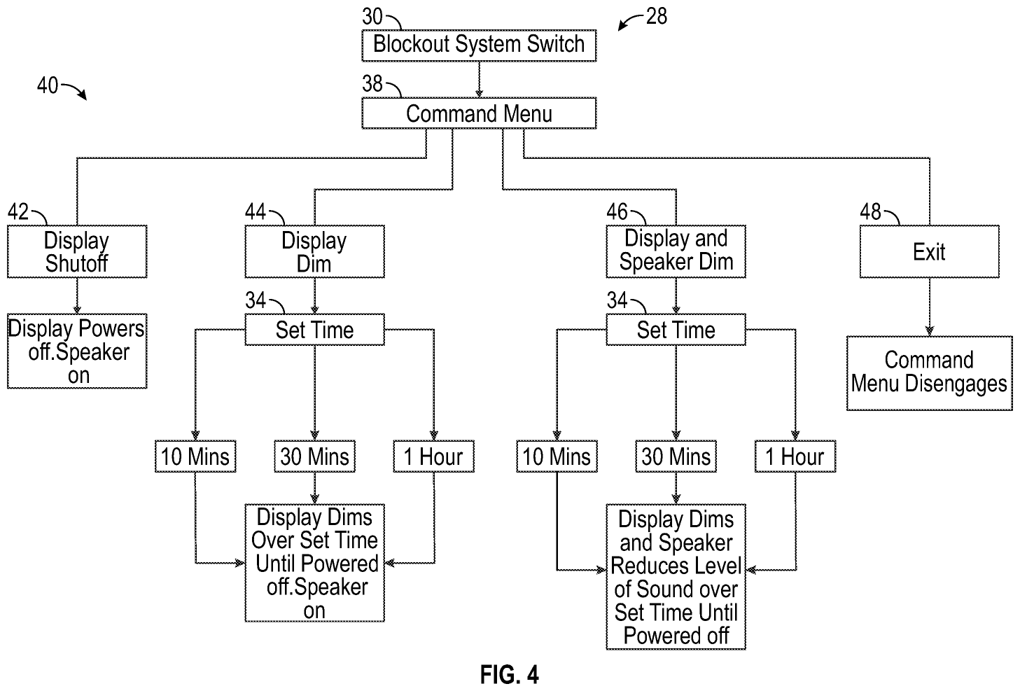

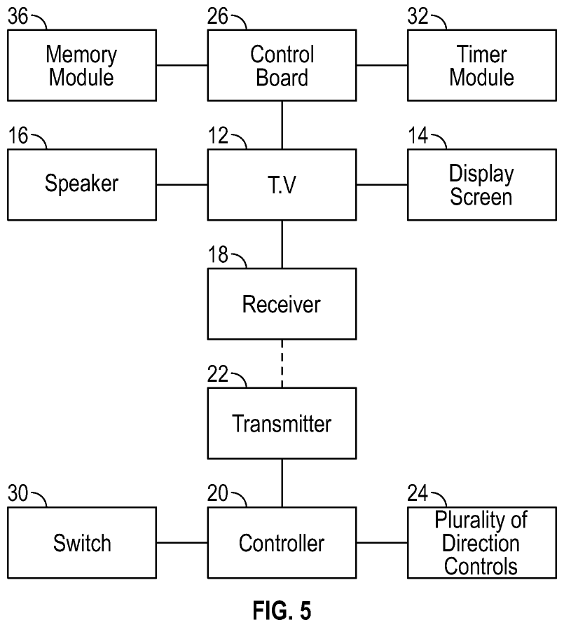

With reference now to the drawings, and in particular to FIGS. 1 through 5 thereof, a new electronic device control system embodying the principles and concepts of an embodiment of the disclosure and generally designated by the reference numeral 10 will be described.

As best illustrated in FIGS. 1 through 5, the television display blackout control system 10 generally comprises a television 12 including a display screen 14 and a speaker 16. The display screen 14, is conventional and may include any LCD, OLED, etc. type display screen used for televisions, computer monitors, and the like, displays a video program when actuated and the speaker 16 emits sound for the video program when actuated. A receiver 18 is typically electrically coupled to the television 12 and a controller 20 typically includes a transmitter 22 for wirelessly communicating with the receiver 18 to actuate the television 12. The controller 20 may include a plurality of direction controls 24 including a forward button, a backward button, an upward button, a downward button, and a selector button.

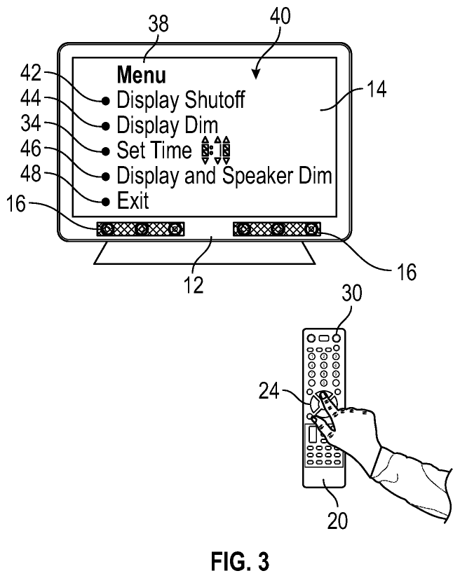

A programmed control circuit 26 is electrically coupled to the display screen 14 and the speaker 16 of the television 12 and is programmed to include a blackout feature 28 to power off or to selectively darken the display screen 14 while continuing to audibly play sound from the speaker 16 for the video program. An actuator 30 of the controller 20 is actuatable to engage the blackout feature 28. A timer module 32 is electrically coupled to the programmed control circuit 26 and counts a set time 34 for engaging the blackout feature 28 when actuated. The set time 34 is selected by a user using the controller 20, as shown in FIG. 3. A memory module 36 is electrically coupled to the programmed control circuit 26 and is programmed to store a command menu 38 including subcommands 40 of the blackout feature 28. The command menu 38 is normally displayed on the display screen 14 when the blackout feature 28 is actuated.

The subcommands 40 of the command menu 38 may typically include a display shutoff command 42 being actuated to power off the display screen 14 while the speaker 16 remains powered to audibly play sound from the video program. The subcommands 40 may also include a display dim command 44 being actuated to dim the display screen 14 incrementally over the set time 34 selected by the user and powering off the display screen 14 when the set time 34 is finished while the speaker 16 remains powered to audibly play sound from the video program.

The subcommands 40 may include a display and speaker dim command 46 being actuated to simultaneously dim the display screen 14 and reduce a level of sound from the speaker 16 to an inaudible level incrementally over the set time 34 selected by the user and thereafter powering off the display screen 14 and the speaker 16 when the set time 34 is finished. An exit command 48 is typically included and is actuated to disengage the blackout feature 38 and remove the command menu 38 from the display screen 14.

In use, the television 12 is powered on to actuate the display screen 14 and the speaker 16. The actuator 30 is engaged with to actuate the blackout feature 38 of the television 12 and to display the command menu 40 on the display screen 14. The plurality of direction controls 24 is engaged with to select one subcommand 40 from the command menu 38. The display dim command 44 and the display and speaker dim command 46 both require a set time 44 to be selected by the user to determine a duration for dimming the display screen 14 incrementally and reducing a level of sound of the speaker 16 to an inaudible level incrementally.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A television control system comprising:
a television including a display screen and a speaker;
a receiver being electrically coupled to said television;
a controller including:
a transmitter for wirelessly communicating with said receiver to actuate said television;
a plurality of direction controls;
a programmed control circuit being electrically coupled to said display screen and said speaker of said television, said programed control circuit being programmed to include a blackout feature to power off or to selectively darken said display screen while continuing to audibly play sound from the speaker for a video program;
an actuator of said controller being actuatable to engage said blackout feature;
a tinier module being electrically coupled to said programmed control circuit and counting a set time for engaging the blackout feature when actuated;
a memory module being electrically coupled to said programmed control circuit and being programmed to store a command menu including subcommands of said blackout feature; and
wherein said command menu is displayed on said display screen when said blackout feature is actuated, further including a display dim command, said display dim command being actuated to dim said display screen incrementally over said set time selected by a user and powering off said display screen when said set time being finished while said speaker remains powered to audibly play sound from the video program.

2. The television control system of claim 1, wherein said display screen displays a video program when actuated, said speaker emitting sound for the video program when actuated.

3. The television control system of claim 1, wherein said direction controls include a forward button, a backward button, an upward button, a downward button, and a selector button.

4. The television control system of claim 1, wherein said set time is selected by a user using said controller.

5. (canceled)

6. The television control system of claim 1, wherein said subcommands of said command menu include a display shutoff command, said display shutoff command being actuated to power off said display screen while said speaker remains powered to audibly play sound from the video program.

7. (canceled)

8. The television control system of claim 1, further including a display and speaker dim command, said display and speaker dim command being actuated to simultaneously dim said display screen and reduce a level of sound from said speaker to an inaudible level incrementally over said set time selected by said user and thereafter powering off said display screen and said speaker when said set time is finished.

9. The television control system of claim 8, further including an exit command, said exit command being actuated to disengage said blackout feature and removing said command menu from said display screen.

10. A television control system comprising:
a television including a display screen and a speaker, said display screen
displaying a video program when actuated, said speaker emitting sound for the video program when actuated;
a receiver being electrically coupled to said television;
a controller including:
a transmitter for wirelessly communicating with said receiver to actuate said television;
a plurality of direction controls, said direction controls include a forward button, a backward button, an upward button, a downward button, and a selector button;
a programmed control circuit being electrically coupled to said display screen and said speaker of said television, said programmed control circuit being programmed to include a blackout feature to power off or to selectively darken said display screen while continuing to audibly play sound from the speaker for the video program;
an actuator of said controller being actuatable to engage said blackout feature;
a tinier module being electrically coupled to said programmed control circuit and counting a set time for engaging the blackout feature when actuated, said set time being selected by a user using said controller;
a memory module being electrically coupled to said programmed control circuit and being programmed to store a command menu including subcommands of said blackout feature, said command menu being displayed on said display screen when said blackout feature is actuated, said subcommands of said command menu including:
a display shutoff command, said display shutoff command being actuated to power off said display screen while said speaker remains powered to audibly play sound from the video program;
a display dim command, said display dim command being actuated to dim said display screen incrementally over said set time selected by said user and powering off said display screen when said set time being finished while said speaker remains powered to audibly play sound from the video program;
a display and speaker dim command, said display and speaker dim command being actuated to simultaneously dim said display screen and reduce a level of sound from said speaker to an inaudible level incrementally over said set time selected by said user and thereafter powering off said display screen and said speaker when said set time is finished; and
an exit command, said exit command being actuated to disengage said blackout feature and removing said command menu from said display screen.

11. A method for actuating a blackout feature for a television including the steps of:
powering on a television to actuate a display screen and a speaker of said television;
engaging with an actuator to actuate a blackout feature of said television and to display a command menu on said display screen;
engaging with a plurality of direction controls to select one subcommand from said command menu; and
wherein said command menu includes a display dim command said display dim command dims said display screen incrementally over a set time selected by a user and powering off said display screen when said set time being finished while said speaker remains powered to audibly play sound from a video program.

12. The method for actuating a blackout feature for a television of claim 11, wherein said command menu includes a display shutoff command, said display shutoff command powers off said display screen of said television while said speaker remains powered to audibly play sound from a video program.

13. (canceled)

14. The method for actuating a blackout feature for a television of claim 11, wherein said command menu includes a display and speaker dim command, said display and speaker dim command simultaneously dims said display screen and reduces a level of sound from said speaker to an inaudible level incrementally over a set time selected by a user and thereafter powering off said display screen and said speaker when said set time is finished.

15. The method for actuating a blackout feature for a television of claim 11, wherein said command menu includes an exit command, said exit command disengages said blackout feature and removes said command menu from said display screen.
